(19) United States
(12) Patent Application Publication
(10) Pub. No.: US 2019/0285256 A1
(43) Pub. Date: Sep. 19, 2019

(54) PORTABLE WORKING LIGTH APPARATUS

(71) Applicant: XIAMEN ECO LIGHTING CO. LTD., Xiamen (CN)

(72) Inventors: Yongxiang Hong, Xiamen (CN); Maojin Zeng, Xiamen (CN); Zhichao You, Xiamen (CN)

(21) Appl. No.: 15/921,641

(22) Filed: Mar. 14, 2018

(51) Int. Cl. F21V 21/30; F21V 17/02; F21V 29/70; F21S 9/02; F21V 23/04; F21S 6/00; F21V 3/00; F21V 17/00

(52) U.S. Cl. CPC F21V 21/30; F21V 17/02; F21V 29/70; F21S 9/02; F21Y 2115/10; F21S 6/005; F21V 3/00; F21V 17/002; F21V 23/04

(57) ABSTRACT

A portable working light apparatus has a light module, a first stand and a second stand. The light module has a back housing and a light source. The first stand is connected to the light module via a first axial connector. The second stand is used for mounting the first stand. The second stand is connected with the first stand with a second axial connector. The first axial connector and the second axial connector provide the light module to adjust a light emitting direction in a degree of freedom of two axes.

### FIELD OF INVENTION

The present invention is related to a working light apparatus and more particularly related to a portable working light apparatus.

### BACKGROUND

There are various light devices in daily life. In modern society, light devices are an important symbol as well as tools to support today's civilization growing.

Some light devices are fixed in the ceiling like downlight devices. Some are placed on table, and some other light devices are used for various working needs. For example, a photographer needs various light devices to create a desired luminous environment. Some light devices need to be portable to be conveniently moved and placed in working environments.

Innovative light devices might not appear important as they are. But it is helpful to enhance human life when various novel light devices are invented and provided to the world. Such innovation may be on decreasing manufacturing cost, adding features, or making light devices more portable or with more functions.

Therefore, it is beneficial to continue find out innovative light designs in such crowded art. Any innovation advancement may bring certain advancement of this society, by finding new design, new technical problems and new technical solutions to bring new products.

### SUMMARY OF INVENTION

According to a first embodiment, a portable working light apparatus has a light module, a first stand and a second stand.

In this embodiment, the light module has a back housing and a light source. The light source has a LED plate mounted with LED modules. The LED plate may include a metal substrate with insulation layers and metal wire patterns thereon. In addition, the LED plate may have addition structure in addition to a flat surface as a heat sink.

The first stand is connected to the light module via a first axial connector. The light module is rotatable along the first axial connector. The term axial connect refers to any axis structure for providing two connected parts to rotate with respect to each other. In other words, a rotation shaft may be used or other rotation mechanism may be used to implement the axial connector mentioned here.

The second stand is used for mounting the first stand. The second stand is connected with the first stand with a second axial connector. The first stand is rotatable along the second axial connector. Similarly, the second axial connector may be implemented with the same mechanism as the first axial connector or a different axis based rotation structure.

The second stand has a bottom structure to be steadily placed on a horizontal surface. The first axial connector and the second axial connector provide the light module to adjust a light emitting direction in a degree of freedom of two axes with respect to the horizontal surface.

In some embodiments, the first stand is rotated along a second virtual axis perpendicular to the horizontal surface. The second virtual axis may be the virtual central axis of a rotation shaft of the second axial connector. Please be noted that the term ‘perpendicular’ may not need to an accurate 90 degrees but may have certain range, e.g. +20 to −20 degrees offset.

In some embodiments, the light module is rotated along a first virtual axis parallel to the horizontal surface for adjusting a tilt angle with respect to the horizontal surface. Similar, the first virtual axis may be a virtual central axis of a rotation shaft of the first axial connector.

In some embodiments, the first axial connector and the second axial connector have rotation knobs for fastening the first axial connector and the second axial connector after rotation. Specifically, a manual handler may be provided for hands to conveniently operate the rotation on the first axial connector and the second axial connector.

In some embodiments, the light module further has a front panel fixed on the back housing, and the first axial connector is disposed on the back housing.

In some embodiments, the light module further has a reflector reflecting light of the LED modules, and the LED plate is a heat sink. The reflector is used for collecting light to undesired direction back to desired output direction.

In some embodiments, the light module further has a waterproof sealing ring between the back housing and the front cover. With a transparent cover and the waterproof sealing ring, the light module may be free of water risk.

In some embodiments, the light module further has a battery located behind the LED plate within the back housing.

In some embodiments, the light module further has a charging interface and a power switch on the external surface of the back housing.

In some embodiments, the back housing is a box structure.

In some embodiments, the first stand is a U shape structure, and the first axial connector has two rotation units respectively located at two ends of the U shape structure. Specifically, the U letter has two ends. The first stand may have two opening for installing rotation shaft on the two ends of the U shape structure.

Furthermore, the middle part of the U shape structure may be a flat elongated bar. A rotation shaft may be installed at the middle of the flat elongated bar. On the other hand, the second stand may have a central bar. The rotation shaft connected to the middle part of the U shape structure may be further connected to the middle of the central bar.

In some embodiments, there are two tubes disposed at two ends of the central bar, and the two tubes are perpendicular to the central bar, forming a H letter structure.

In addition, there may be plastic caps installed at ends of the two tubes for anti-skidding.

In some embodiments, the central bar has an interface to connect to a standard camera tripod. In other words, the portable working light apparatus may be placed on a table surface, or may be placed on a standard camera tripod.

In some embodiments, a power switch is installed on the first axial connector. Furthermore, the light module may be turned on by rotating the light module to trigger the power switch hidden inside.

In some embodiments, the bottom structure has a battery for supplying power to the light module.

In some embodiments, the light module has a replaceable front cover for changing output light characteristic. For example, there may be multiple front covers with different half intensity angles to be selected and replaced. Color filters may be used for adjusting output light of the light module, too.

### BRIEF DESCRIPTION OF DRAWINGS

FIG. 1 illustrates a working light apparatus embodiment.

FIG. 2 illustrates another status of the embodiment of FIG. 1.

FIG. 3 illustrates a rotation status of the embodiment.

FIG. 4 illustrates a rotation along another axis.

FIG. 5 illustrates another rotation example.

FIG. 6 illustrates an exploded component diagram of the embodiment.

FIG. 7 illustrates an exploded view of components of the embodiment.

FIG. 8 illustrates the working light apparatus mounted on a standard tripod support.

### DETAILED DESCRIPTION

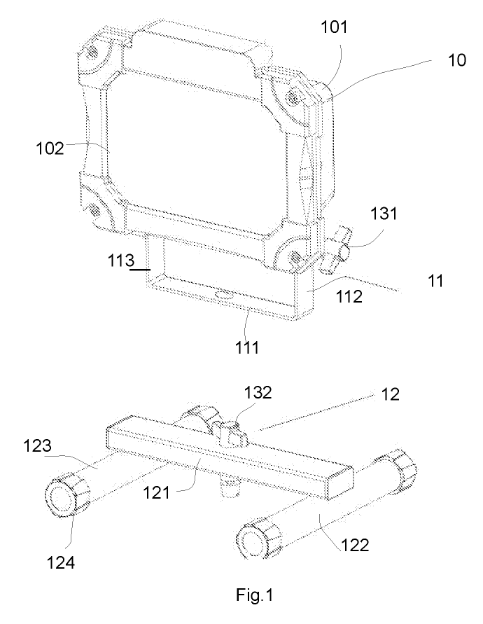

Please refer to FIG. 1. FIG. 1 illustrates a working light apparatus embodiment.

In FIG. 1, a working light apparatus includes a light module 10, a first stand 11 and a second stand 12. The light module 10 has a back housing 101 and a front panel 102. The front panel 102 has an opening where light is emitted from.

The first stand is a U shape structure with two ends respectively disposed with two rotation units of a first axial connector 131. The first stand also has a flat elongated bar 111. In the middle of the flat elongated bar, there is a hole for installing a rotation shaft as a component of a second axial connector 132.

The second axial connector 132 connects the flat elongated bar 111 with a central bar 121 of the second stand. The second stand 12, in this example, is a H shape structure. In addition to the central bar 121, there are two perpendicularly connected tubes 122 and 123 with their ends attached with anti-skidding caps.

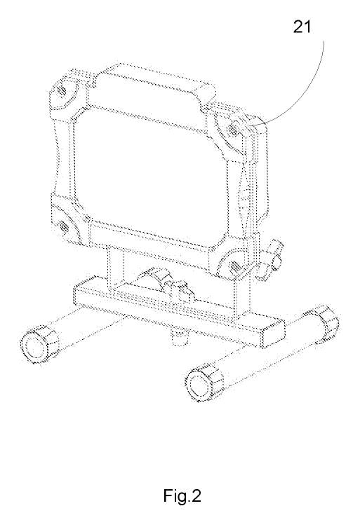

Please refer to FIG. 2. FIG. 2 illustrates another status of the embodiment of FIG. 1.

Firstly, as illustrated in FIG. 1 and FIG. 2, the light module 21 may be detached from the first stand and/or the second stand. In some embodiments, when the light module 21 and the first stand are detached from the second stand, the first stand may be rotated as a support for the light module 21 to adjust a tilt angle of the light module with respect to a horizontal surface the first stand the light module 21 are standing thereon.

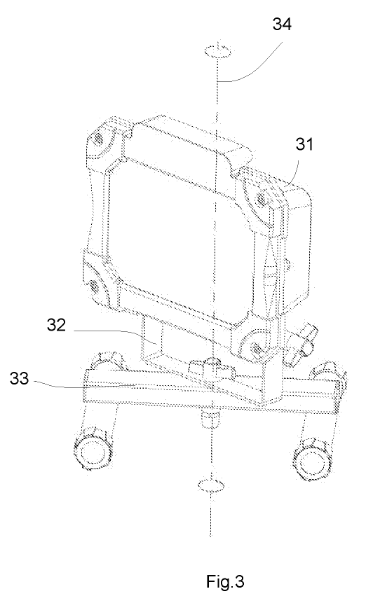

Please refer to FIG. 3. FIG. 3 illustrates a rotation status of the embodiment.

In FIG. 3, it is illustrated how the light module 31 and the first stand 32 are rotated with respect to the second stand 33 along a virtual axis 34 corresponding to the second axial connector.

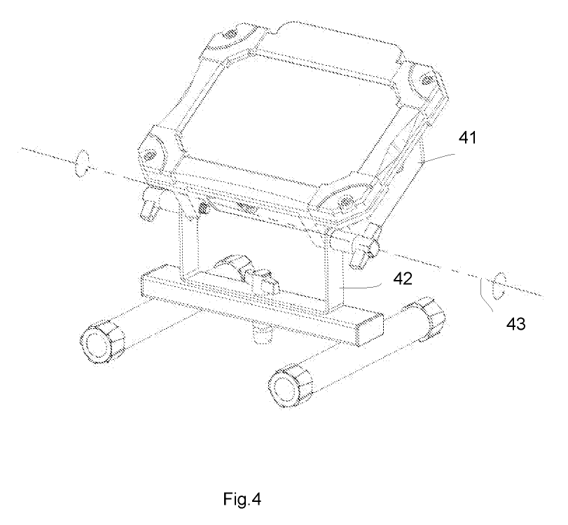

Please refer to FIG. 4. FIG. 4 illustrates a rotation along another axis.

In FIG. 4, it is illustrated how the light module 41 is rotated with respect to the first stand 42 along a virtual axis 43 corresponding to the first axial connector.

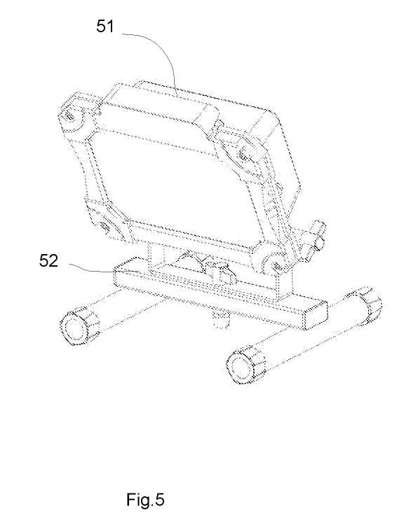

Please refer to FIG. 5. FIG. 5 illustrates another rotation example.

In FIG. 5, the light module 51 is rotated to another tilt angle with respect to the second stand 52. From FIG. 3, FIG. 4 and FIG. 5, it is clear that with such rotation mechanism, the light module has degree of freedom in two axes.

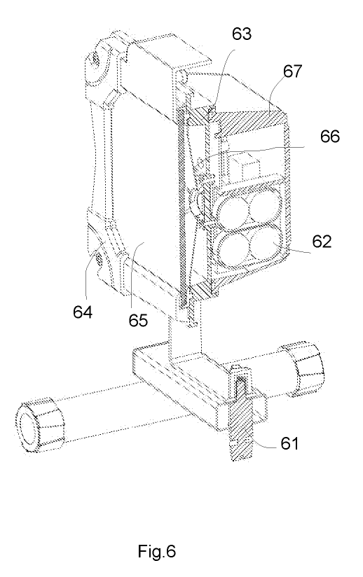

Please refer to FIG. 6. FIG. 6 illustrates an exploded component diagram of the embodiment.

In FIG. 6, the light module has a back housing 67 which may be made of plastic material. A heat sink 63 attached to a light source for help heat dissipation. A battery 62 is used for keeping the working light apparatus portable. A lens cover 65 with focus function or diffusion function and the reflector 66 may be used for adjust light characteristic.

The front panel 64 may be used for assembling and protect inner components. The shaft 61 with a knob may be used for implementing the axial connector.

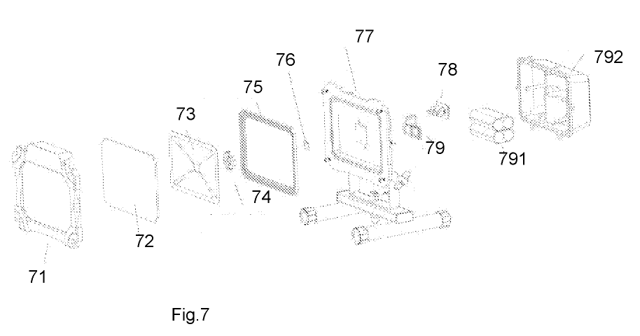

FIG. 7 illustrates an exploded view of components of the embodiment.

In FIG. 7, the embodiment has a front panel 71, a lens cover 72, a reflector 73, a pressing unit 74, a sealing ring 75, a LED module 76, a heat sink 77, a power switch 79, a power interface 78, a battery 791 and a back housing 792. These components for an exemplary light module. However, please be noted that such configuration is not used to limit the invention scope.

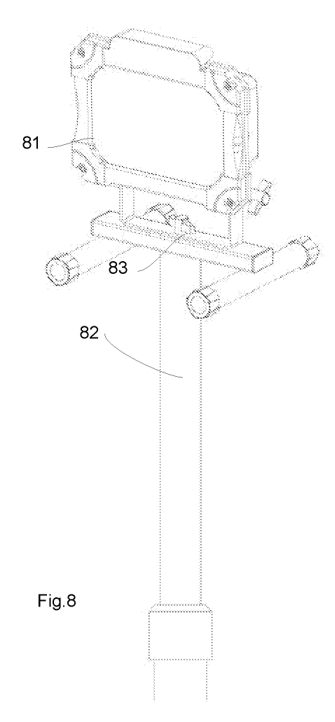

Please refer to FIG. 8. FIG. 8 illustrates the working light apparatus mounted on a standard tripod support.

In addition to place the working light module on table surface, the working light module may also be placed on a standard camera tripod. The term ‘tripod’ does not limit to a support with three legs. Any standard camera support may be the tripod mentioned here. In addition, customized connector for connecting to a proprietary support may also be applicable, depending on design needs.

According to a first embodiment, a portable working light apparatus has a light module, a first stand and a second stand.

In this embodiment, the light module has a back housing and a light source. The light source has a LED plate mounted with LED modules. The LED plate may include a metal substrate with insulation layers and metal wire patterns thereon. In addition, the LED plate may have addition structure in addition to a flat surface as a heat sink.

The first stand is connected to the light module via a first axial connector. The light module is rotatable along the first axial connector. The term axial connect refers to any axis structure for providing two connected parts to rotate with respect to each other. In other words, a rotation shaft may be used or other rotation mechanism may be used to implement the axial connector mentioned here.

The second stand is used for mounting the first stand. The second stand is connected with the first stand with a second axial connector. The first stand is rotatable along the second axial connector. Similarly, the second axial connector may be implemented with the same mechanism as the first axial connector or a different axis based rotation structure.

The second stand has a bottom structure to be steadily placed on a horizontal surface. The first axial connector and the second axial connector provide the light module to adjust a light emitting direction in a degree of freedom of two axes with respect to the horizontal surface.

In some embodiments, the first stand is rotated along a second virtual axis perpendicular to the horizontal surface. The second virtual axis may be the virtual central axis of a rotation shaft of the second axial connector. Please be noted that the term ‘perpendicular’ may not need to an accurate 90 degrees but may have certain range, e.g. +20 to −20 degrees offset.

In some embodiments, the light module is rotated along a first virtual axis parallel to the horizontal surface for adjusting a tilt angle with respect to the horizontal surface. Similar, the first virtual axis may be a virtual central axis of a rotation shaft of the first axial connector.

In some embodiments, the first axial connector and the second axial connector have rotation knobs for fastening the first axial connector and the second axial connector after rotation. Specifically, a manual handler may be provided for hands to conveniently operate the rotation on the first axial connector and the second axial connector.

In some embodiments, the light module further has a front panel fixed on the back housing, and the first axial connector is disposed on the back housing.

In some embodiments, the light module further has a reflector reflecting light of the LED modules, and the LED plate is a heat sink. The reflector is used for collecting light to undesired direction back to desired output direction.

In some embodiments, the light module further has a waterproof sealing ring between the back housing and the front cover. With a transparent cover and the waterproof sealing ring, the light module may be free of water risk.

In some embodiments, the light module further has a battery located behind the LED plate within the back housing.

In some embodiments, the light module further has a charging interface and a power switch on the external surface of the back housing.

In some embodiments, the back housing is a box structure.

In some embodiments, the first stand is a U shape structure, and the first axial connector has two rotation units respectively located at two ends of the U shape structure. Specifically, the U letter has two ends. The first stand may have two opening for installing rotation shaft on the two ends of the U shape structure.

Furthermore, the middle part of the U shape structure may be a flat elongated bar. A rotation shaft may be installed at the middle of the flat elongated bar. On the other hand, the second stand may have a central bar. The rotation shaft connected to the middle part of the U shape structure may be further connected to the middle of the central bar.

In some embodiments, there are two tubes disposed at two ends of the central bar, and the two tubes are perpendicular to the central bar, forming a H letter structure.

In addition, there may be plastic caps installed at ends of the two tubes for anti-skidding.

In some embodiments, the central bar has an interface to connect to a standard camera tripod. In other words, the portable working light apparatus may be placed on a table surface, or may be placed on a standard camera tripod.

In some embodiments, a power switch is installed on the first axial connector. Furthermore, the light module may be turned on by rotating the light module to trigger the power switch hidden inside.

In some embodiments, the bottom structure has a battery for supplying power to the light module.

In some embodiments, the light module has a replaceable front cover for changing output light characteristic. For example, there may be multiple front covers with different half intensity angles to be selected and replaced. Color filters may be used for adjusting output light of the light module, too.

In addition to the above-described embodiments, various modifications may be made, and as long as it is within the spirit of the same invention, the various designs that can be made by those skilled in the art are belong to the scope of the present invention.

1. A portable working light apparatus, comprising:
a light module having a back housing and a light source, the light source having a LED plate mounted with LED modules;
a first stand connected to the light module via a first axial connector, the light module being rotatable along the first axial connector; and
a second stand for mounting the first stand, the second stand being connected with the first stand with a second axial connector, the first stand being rotatable along the second axial connector, the second stand having a bottom structure to be steadily placed on a horizontal surface, the first axial connector and the second axial connector providing the light module to adjust a light emitting direction in a degree of freedom of two axes with respect to the horizontal surface, wherein the second stand has a central bar, and the central bar has an interface to connect to a standard camera tripod.

2. The portable working light apparatus of claim 1, wherein the first stand is rotated along a second virtual axis perpendicular to the horizontal surface.

3. The portable working light apparatus of claim 2, wherein the light module is rotated along a first virtual axis parallel to the horizontal surface for adjusting a tilt angle with respect to the horizontal surface.

4. The portable working light apparatus of claim 3, wherein the first axial connector and the second axial connector have rotation knobs for fastening the first axial connector and the second axial connector after rotation.

5. The portable working light apparatus of claim 4, wherein the light module further has a front panel fixed on the back housing, and the first axial connector is disposed on the back housing.

6. The portable working light apparatus of claim 5, wherein the light module further has a reflector reflecting light of the LED modules, and the LED plate is a heat sink.

7. The portable working light apparatus of claim 6, wherein the light module further has a waterproof sealing ring between the back housing and the front cover.

8. The portable working light apparatus of claim 6, wherein the light module further has a battery located behind the LED plate within the back housing.

9. The portable working light apparatus of claim 6, wherein the light module further has a charging interface and a power switch on the external surface of the back housing.

10. The portable working light apparatus of claim 6, wherein the back housing is a box structure.

11. The portable working light apparatus of claim 6, wherein the first stand is a U shape structure, and the first axial connector has two rotation units respectively located at two ends of the U shape structure.

12. The portable working light apparatus of claim 11, wherein the middle part of the U shape structure is a flat elongated bar, a rotation shaft is installed at the middle of the flat elongated bar.

13. The portable working light apparatus of claim 12, wherein the rotation shaft is connected to the middle of the central bar.

14. The portable working light apparatus of claim 13, wherein there are two tubes disposed at two ends of the central bar, and the two tubes are perpendicular to the central bar.

15. The portable working light apparatus of claim 14, wherein there are plastic caps installed at ends of the two tubes for anti-skidding.

16. (canceled)

17. The portable working light apparatus of claim 1, wherein a power switch is installed on the first axial connector.

18. The portable working light apparatus of claim 1, wherein the bottom structure has a battery for supplying power to the light module.

19. The portable working light apparatus of claim 1, wherein the light module has a replaceable front cover for changing output light characteristic.

20. The portable working light apparatus of claim 19, wherein there are multiple front covers with different half intensity angles to be selected and replaced.
